(19) United States
(12) Patent Application Publication
(10) Pub. No.: US 2014/0113804 A1
(43) Pub. Date: Apr. 24, 2014

(54) ASYMMETRIC PHOSPHONIUM HALOALUMINATE IONIC LIQUID COMPOSITIONS

(71) Applicant: UOP LLC, Des Plaines, IL (US)

(72) Inventors: Susie C. Martins, Carol Stream, IL (US); Douglas A. Nafis, Mount Prospect, IL (US); Alakananda Bhattacharyya, Glen Ellyn, IL (US)

(73) Assignee: Cytec Industries Inc., Stamford, CT (US)

(21) Appl. No.: 14/136,660

(22) Filed: Dec. 20, 2013

Related U.S. Application Data
(63) Continuation-in-part of application No. 13/796,646, filed on Mar. 12, 2013.
(60) Provisional application No. 61/664,385, filed on Jun. 26, 2012.

(51) Int. Cl. B01J 31/02

(52) U.S. Cl. CPC B01J 31/0298
USPC 502/164; 568/9

(57) ABSTRACT

Quaternary phosphonium haloaluminate compounds according to Formula (I):

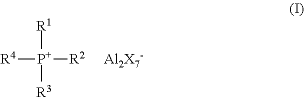

are provided herein, wherein
R¹-R³ are the same or different and each is chosen from a hydrocarbyl;
R⁴ is different than R¹-R³ and is chosen from a hydrocarbyl; and
X is a halogen.

### CROSS-REFERENCE TO RELATED APPLICATIONS

This application is a continuation-in-part of U.S. application Ser. No. 13/796,646 filed Mar. 12, 2013, which claims the benefit of U.S. Provisional Application No. 61/664,385 filed on Jun. 26, 2012. This application is also related to co-pending U.S. application Ser. No. 13/796,776 filed Mar. 12, 2013; and co-pending U.S. application Ser. No. 13/796,814 filed Mar. 12, 2013. Each of these applications is incorporated herein by reference in its entirety.

### FIELD OF THE INVENTION

This invention relates to phosphonium-halide salts. More specifically, the invention relates to phosphonium-haloaluminate compounds as ionic liquids, which, in certain embodiments, are useful as catalysts in processes for the alkylation of paraffins with olefins.

### BACKGROUND OF THE INVENTION

Ionic liquids are essentially salts in a liquid state at room temperature or even below room temperature, and will form liquid compositions at temperature below the individual melting points of the constituents. Ionic liquids are generally described in U.S. Pat. Nos. 4,764,440; 5,104,840; and 5,824,832 among others. While ionic liquids generally provide non-aqueous, polar solvents with a wide liquid range and a high degree of thermal stability, the properties can vary extensively for different ionic liquids, and the use of ionic liquids depends on the properties of a given ionic liquid. Depending on the organic cation of the ionic liquid and the anion, the ionic liquid can have very different properties. The behavior varies considerably for different temperature ranges, and it is preferred to find ionic liquids that do not require operation under more extreme conditions such as refrigeration.

The alkylation of paraffins with olefins for the production of alkylate for gasolines can use a variety of catalysts. Typically, strong acid catalysts such as hydrofluoric acid or sulfuric acid are used. The choice of catalyst depends on the end product a producer desires. Ionic liquids are catalysts that can be used in a variety of catalytic reactions, including the alkylation of paraffins with olefins. However, while the use of ionic liquids may have some merits and applicability in alkylate production, they are not currently in widespread use. Accordingly, the environmentally unfriendly compositions and methods presently available for alkylate production require further improvement. Alternative catalytic compositions and formulations that effectively produce high quality alkylates via a safer and cleaner technology, and that is also economically feasible, would be a useful advance in the art and could find rapid acceptance in the industry.

### SUMMARY OF THE INVENTION

The forgoing and additional objects are attained in accordance with the principles of the invention wherein the inventors detail the surprising discovery that certain phosphonium haloaluminate salts are more effective as ionic liquid catalysts, as compared to nitrogen-based ionic liquid catalysts, and provide better Research Octane Numbers (RON) when reacting olefins and isoparaffins to produce high octane alkylates even at reaction temperatures of 50° C.

Accordingly, in one aspect the present invention provides quaternary phosphonium haloaluminate compounds according to Formula (I):

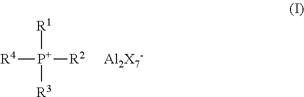

wherein

R¹-R³ are the same or different and each is chosen from a hydrocarbyl;

R⁴ is different than R¹-R³ and is chosen from a hydrocarbyl; and

X is a halogen.

In another aspect, the present invention provides ionic liquid compositions comprising one or more quaternary phosphonium haloaluminate compounds as defined herein.

In still another aspect, the invention provides ionic liquid catalysts for reacting olefins and isoparaffins to generate an alkylate, wherein the catalysts include one or more quaternary phosphonium haloaluminate compound as defined herein, or an ionic liquid composition as defined herein.

These and other objects, features and advantages of this invention will become apparent to those skilled in the art from the following detailed description of the various embodiments of the invention taken in conjunction with the accompanying Figures and Examples.

### BRIEF DESCRIPTION OF THE DRAWINGS

FIG. 1 shows the kinematic viscosity curves of a series of chloroaluminate ionic liquids over a range of temperatures;

FIG. 2 shows the effect of asymmetric side chain length on alkylation performance of phosphonium-chloroaluminate ionic liquids;

FIG. 3 shows the effect of symmetric side chain length on alkylation performance of phosphonium-chloroaluminate ionic liquids;

FIG. 4 shows a comparison of the alkylation performance of phosphonium-based and nitrogen-based ionic liquids; and

FIG. 5 shows the effect of temperature on product selectivity for P-based vs. N-based chloroaluminate ionic liquids.

### DETAILED DESCRIPTION OF THE INVENTION

Ionic liquids have been presented in the literature, and in patents. Ionic liquids can be used for a variety of catalytic reactions, and it is of particular interest to use ionic liquids in alkylation reactions. Ionic liquids, as used hereinafter, refer to the complex of mixtures where the ionic liquid comprises an organic cation and an anionic compound where the anionic compound is usually an inorganic anion. Although these catalysts can be very active, with alkylation reactions it is required to run the reactions at low temperatures, typically between −10° C. to 0° C., to maximize the alkylate quality. This requires cooling the reactor and reactor feeds, and adds substantial cost in the form of additional equipment and energy for using ionic liquids in the alkylation process. The most common ionic liquid catalyst precursors for the alkylation application include imidazolium, or pyridinium-based, cations coupled with the chloroaluminate anion (Al₂Cl₇⁻).

The anionic component of the ionic liquid generally comprises a haloaluminate of the form AlₙX₃ₙ₊₁, where n is from 1 to 5. The most common halogen, Ha, is chlorine, or Cl. The ionic liquid mixture can comprise a mix of the haloaluminates where n is 1 or 2, and include small amount of the haloaluminates with n equal to 3 or greater. When water enters the reaction, whether brought in with a feed, or otherwise, there can be a shift, where the haloaluminate forms a hydroxide complex, or instead of AlₙX₃ₙ₊₁, AlₙXₘ(OH)ₓ is formed where m+x=3n+1. An advantage of ionic liquids (IL) for use as a catalyst is the tolerance for some moisture. While the moisture is not desirable, catalysts tolerant to moisture provide an advantage. In contrast, solid catalysts used in alkylation generally are rapidly deactivated by the presence of water. Ionic liquids also present some advantages over other liquid alkylation catalysts, such as being less corrosive than catalysts like HF, and being non-volatile.

It has now been surprisingly found that alkylation reactions using phosphonium-based haloaluminate ionic liquids give high octane products when carried out at temperatures above or near ambient temperature. This provides for an operation that can substantially save on cost by removing refrigeration equipment from the process. Accordingly, in one aspect the present invention provides quaternary phosphonium haloaluminate compounds according to Formula (I):

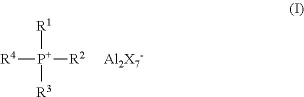

wherein

R¹-R³ are the same or different and each is chosen from a C₁-C₈ hydrocarbyl;

R⁴ is different than R¹-R³ and is chosen from a C₁-C₁₅ hydrocarbyl; and

X is a halogen.

However, as a proviso, the quaternary phosphonium haloaluminate compounds according to Formula (I) do not include the compound tributylbenzylphosphonium-Al₂Cl₇.

The term “hydrocarbyl” as used herein is a generic term encompassing aliphatic (linear or branched), alicyclic, and aromatic groups having an all-carbon backbone and consisting of carbon and hydrogen atoms, typically from 1 to 36 carbon atoms in length. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, alkaryl, aralkenyl and aralkynyl groups. Those skilled in the art will appreciate that while preferred embodiments are discussed in more detail below, multiple embodiments of the phosphonium haloaluminate compounds according to Formula (I) as defined above are contemplated as being within the scope of the present invention.

While those skilled in the art will appreciate that the asymmetric quaternary phosphonium haloaluminates according to Formula (I) are ionic liquids themselves, the present invention also contemplates ionic liquid compositions having one or more phosphonium haloaluminate described herein, in any possible ratio. In a preferred embodiment, the ionic liquid composition includes a mixture of tributylhexylphosphonium-Al₂Cl₇ and tributylpentylphosphonium-Al₂Cl₇.

In another aspect, the present invention provides a process for the alkylation of paraffins using a phosphonium based ionic liquid. The process of the present invention can be run at room temperature or above in an alkylation reactor to generate an alkylate product stream with high octane. The process includes passing a paraffin having from 2 to 10 carbon atoms to an alkylation reactor, and in particular an isoparaffin having from 4 to 10 carbon atoms to the alkylation reactor. An olefin having from 2 to 10 carbon atoms is passed to the alkylation reactor. The olefin and isoparaffin are reacted in the presence of an ionic liquid catalyst and at reaction conditions to generate an alkylate. The ionic liquid catalyst is a phosphonium based haloaluminate ionic liquid coupled with a Brønsted acid co-catalyst selected from the group consisting of HCl, HBr, HI and mixtures thereof.

In certain embodiments, phosphonium based ionic liquids suitable for use as a catalyst for alkylation include, but are not limited to, trihexyl-tetradecyl phosphonium-Al₂X₇, tributyl-hexylphosphonium-Al₂X₇, tripropylhexylphosphonium-Al₂X₇, tributylmethylphosphonium-Al₂X₇, tributylpentylphosphonium-Al₂X₇, tributylheptylphosphonium-Al₂X₇, tributyloctylphosphonium-Al₂X₇, tributylnonylphosphonium-Al₂X₇, tributyldecylphosphonium-Al₂X₇, tributylundecylphosphonium-Al₂X₇, tributyldodecylphosphonium-Al₂X₇, tributyltetradecylphosphonium-Al₂X₇, and mixtures thereof. X comprises a halogen ion selected from the group consisting of F, Cl, Br, I, and mixtures thereof. A preferred ionic liquid in certain embodiments can be tri-n-butyl-hexylphosphonium-Al₂Ha₇, or tri-n-butyl-n-hexylphosponium-Al₂Ha₇, where the preferred halogen, X, is selected from Cl, Br, I and mixtures thereof. Another preferred ionic liquid is tributylpentylphosphonium-Al₂X₇, wherein X comprises a halogen ion selected from the group consisting of Cl, Br, I and mixtures thereof. Another preferred ionic liquid is tributyloctylphosphonium Al₂X₇, wherein X comprises a halogen ion selected from the group consisting of Cl, Br, I and mixtures thereof. In particular, the most common halogen, X, used is Cl.

The specific examples of ionic liquids in the processes of the present invention use asymmetric phosphonium based ionic liquids mixed with aluminum chloride. The acidity should be controlled to provide for suitable alkylation conditions. The ionic liquid is generally prepared to a full acid strength with balancing through the presence of a co-catalyst, such as a Brønsted acid. HCl or any Brønsted acid may be employed as co-catalyst to enhance the activity of the catalyst by boosting the overall acidity of the ionic liquid-based catalyst.

The reaction conditions include a temperature greater than 0° C. with a preferred temperature greater than 20° C. Ionic liquids can also solidify at moderately high temperatures, and therefore it is preferred to have an ionic liquid that maintains its liquid state through a reasonable temperature span. A preferred reaction operating condition includes a temperature greater than or equal to 20° C. and less than or equal to 70° C. A more preferred operating range includes a temperature greater than or equal to 20° C. and less than or equal to 50° C.

Due to the low solubility of hydrocarbons in ionic liquids, olefins-isoparaffins alkylation, like most reactions in ionic liquids is generally biphasic and takes place at the interface in the liquid phase. The catalytic alkylation reaction is generally carried out in a liquid hydrocarbon phase, in a batch system, a semi-batch system or a continuous system using one reaction stage as is usual for aliphatic alkylation. The isoparaffin and olefin can be introduced separately or as a mixture. The molar ratio between the isoparaffin and the olefin is in the range 1 to 100, for example, advantageously in the range 2 to 50, preferably in the range 2 to 20.

In a semi-batch system the isoparaffin is introduced first then the olefin, or a mixture of isoparaffin and olefin. The catalyst is measured in the reactor with respect to the amount of olefins, with a catalyst to olefin weight ratio between 0.1 and 10, and preferably between 0.2 and 5, and more preferably between 0.5 and 2. Vigorous stirring is desirable to ensure good contact between the reactants and the catalyst. The reaction temperature can be in the range 0° C. to 100° C., preferably in the range 20° C. to 70° C. The pressure can be in the range from atmospheric pressure to 8000 kPa, preferably sufficient to keep the reactants in the liquid phase. Residence time of reactants in the vessel is in the range of a few seconds to hours, preferably 0.5 min to 60 min. The heat generated by the reaction can be eliminated using any of the means known to the skilled person. At the reactor outlet, the hydrocarbon phase is separated from the ionic liquid phase by gravity settling based on density differences, or by other separation techniques known to those skilled in the art. Then the hydrocarbons are separated by distillation and the starting isoparaffin which has not been converted is recycled to the reactor.

Typical alkylation conditions may include a catalyst volume in the reactor of from 1 vol % to 50 vol %, a temperature of from 0° C. to 100° C., a pressure of from 300 kPa to 2500 kPa, an isobutane to olefin molar ratio of from 2 to 20 and a residence time of 5 min to 1 hour.

In some embodiments, the alkylation reactor can be operated at reaction conditions, and with a chloroaluminate ionic liquid catalyst, wherein the kinematic viscosity of the catalyst is at least 50 cSt at 20° C. The kinematic viscosity is a good measurement for non-Newtonian systems of fluids, where the fluid under shearing conditions has a changing viscosity.

In certain embodiments, the reaction conditions include maintaining a temperature greater than 0° C., and the ionic liquid catalyst should be in a liquid state and have appropriate viscosity for the reaction to proceed. Preferably, the reaction conditions do not require cooling below environmental temperatures or conditions. Therefore, it is preferable that reaction conditions include a temperature greater than 20° C., with a preferred operating range between 20° C. and 70° C., and a more preferred operating range between 20° C. and 50° C. As the temperature of the operation increases, it is preferred that the kinematic viscosity does not drop too sharply. It is preferred to maintain a kinematic viscosity of at least 20 cSt at 50° C.

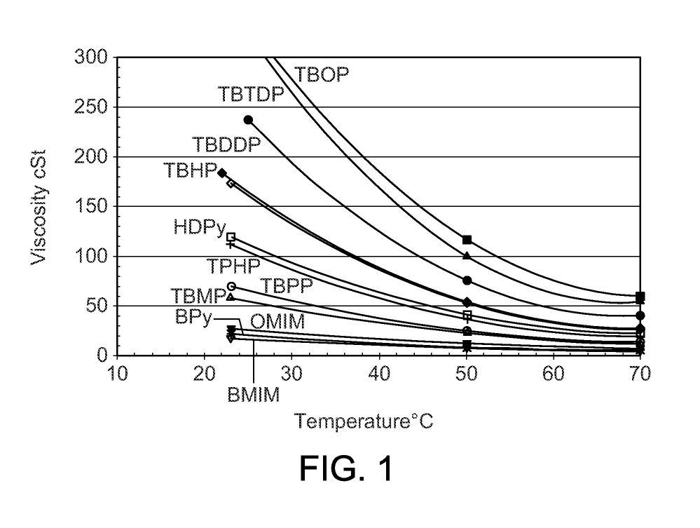

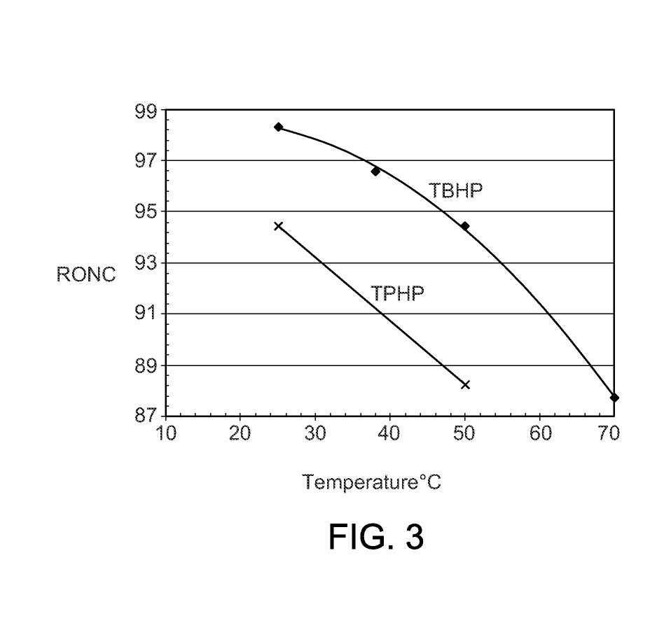

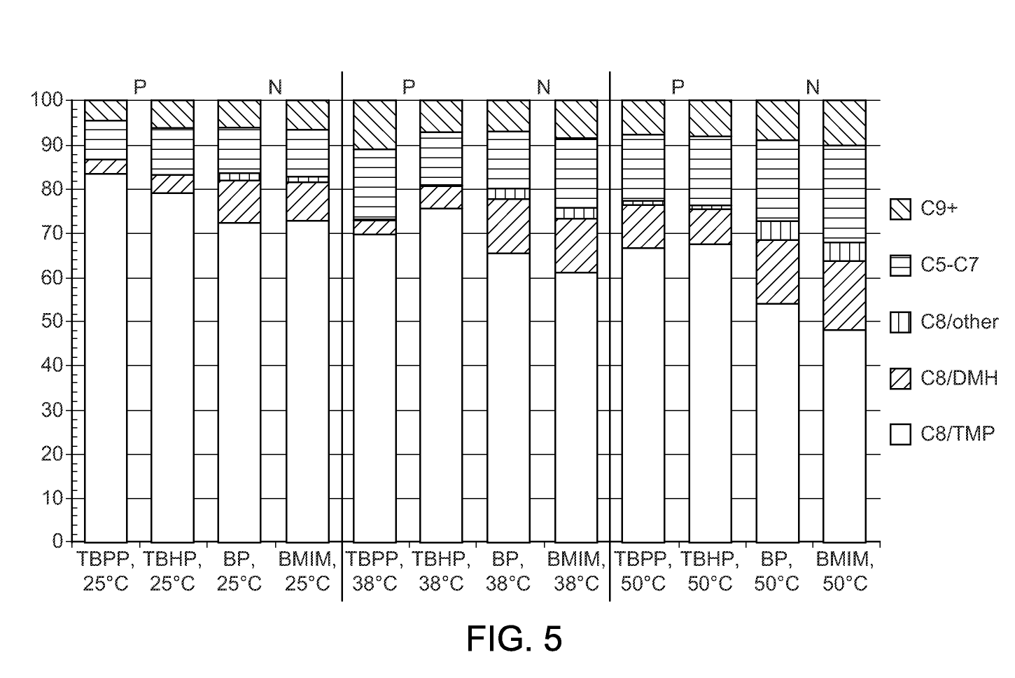

As shown in FIG. 1, the kinematic viscosities of phosphonium based ionic liquids according to the invention are higher than nitrogen based ionic liquids of the prior art over the temperature range desired in the process of the present invention. The ionic liquids in FIG. 1 are: phosphonium based: TBDDP—tributyldodecylphosphonium, TBTDP—tributyltetradecylphosphonium, TBOP—tributyloctylphosphonium, TBHP—tributylhexylphosphonium, TBPP—tributylpentylphosphonium, TBMP—tributylmethylphosphonium, TPHP—tripropylhexylphosphonium, and nitrogen based: HDPy—hexadecyl pyridinium, OMIM—octylmethyl-imidazolium, BMIM—butyl-methyl-imidazolium, and BPy—butyl pyridinium. FIGS. 3 and 5 show the product quality of an alkylate produced by different ionic liquids. The phosphonium based ionic liquids according to the present invention generated an alkylate product that consistently had a higher RONC, showing that product quality was consistently better for the processes of the present invention.

The paraffin used in the alkylation process preferably comprises a paraffin or an isoparaffin having from 4 to 8 carbon atoms, and more preferably having from 4 to 5 carbon atoms. The olefin used in the alkylation process preferably has from 3 to 8 carbon atoms, and more preferably from 3 to 5 carbon atoms. One of the objectives is to upgrade low value C₄ hydrocarbons to higher value alkylates. To that extent, one specific embodiment is the alkylation of butanes with butenes to generate C₈ compounds. Preferred products include trimethylpentane (TMP), and while other C₈ isomers are produced, one competing isomer is dimethylhexane (DMH). The quality of the product stream can be measured in the ratio of TMP to DMH, with a high ratio desired.

In another embodiment, the invention comprises passing an isoparaffin and an olefin to an alkylation reactor, where the alkylation reactor includes an ionic liquid catalyst to react the olefin with the isoparaffin to generate an alkylate. The isoparaffin can include paraffins, and has from 4 to 10 carbon atoms, and the olefin has from 2 to 10 carbon atoms. In some embodiments, the ionic liquid catalyst comprises a quaternary phosphonium haloaluminate compound according to Formula (I), where R¹, R², R³, and R⁴ are alkyl groups having between 4 and 12 carbon atoms, and X is a halogen from the group F, Cl, Br, I, and mixtures thereof.

In certain embodiments, the compounds according to Formula (I) include those where R¹, R² and R³ alkyl groups are the same alkyl group, and the R⁴ comprises a different alkyl group, wherein the R⁴ group is larger than the R¹ group, and that HR⁴ has a boiling point of at least 30° C. greater than the boiling point of HR¹, at atmospheric pressure.

In one embodiment, R¹, R² and R³ comprise an alkyl group having from 3 to 6 carbon atoms, with a preferred structure of R¹, R² and R³ having 4 carbon atoms. In this embodiment, the R⁴ group comprises an alkyl group having between 5 and 8 carbon atoms, with a preferred structure of R⁴ having 6 carbon atoms. In this embodiment, the preferred quaternary phosphonium halide complex is tributylhexylphosphonium-Al₂Cl₇.

In another embodiment, the invention comprises passing an isoparaffin and an olefin to an alkylation reactor, where the alkylation reactor includes an ionic liquid catalyst to react the olefin with the isoparaffin to generate an alkylate. The isoparaffin can include paraffins, and has from 4 to 10 carbon atoms, and the olefin has from 2 to 10 carbon atoms. In some embodiments, the ionic liquid catalyst comprises a quaternary phosphonium haloaluminate compound according to Formula (I), where R¹, R², R³, and R⁴ are alkyl groups having between 4 and 12 carbon atoms. The structure further includes that the R¹, R² and R³ alkyl groups are the same alkyl group, and the R⁴ comprises a different alkyl group, wherein the R⁴ group is larger than the R¹ group, and that R⁴ has at least 1 more carbon atoms than the R¹ group.

While the phosphonium-based haloaluminate compounds and ionic liquids described herein have been contemplated for use as catalysts for reacting olefins and isoparaffins to generate an alkylate, those skilled in the art will also appreciate that these compounds are suitable for use with other applications including, but not limited to, Friedel-Craft catalyst reactions for the dimerization, oligomerization and/or polymerization of olefins; alkylation of olefins and aromatic hydrocarbons; Friedel-Craft acylation reactions; as solvents to replace organic solvents; as solvents for conversions of biomass to ethanol; for removal of sulfur compounds from hydrocarbons; as electrolytes for energy storage devices such as batteries and capacitors, including super capacitors; for removal of aromatic hydrocarbons and alkenes from hydrocarbons, such as separating olefins (e.g., ethylene) from non-olefins; and for carbonylation of alcohols.

The following examples are provided to assist one skilled in the art to further understand certain embodiments of the present invention. These examples are intended for illustration purposes and are not to be construed as limiting the scope of the present invention.

### EXAMPLES

### Example 1

### Preparation of Tributyldodecyl Phosphonium Chloroaluminate Ionic Liquid

Tributyldodecyl phosphonium chloroaluminate is a room temperature ionic liquid prepared by mixing anhydrous tributyldodecyl phosphonium chloride with slow addition of 2 moles of anhydrous aluminum chloride in an inert atmosphere. After several hours of mixing, a pale yellow liquid is obtained. The resulting acidic IL was used as the catalyst for the alkylation of isobutane with 2-butenes.

### Example 2

### Alkylation of Isobutane with 2-Butene Using Tributyldodecylphosphonium-Al₂Cl₇ Ionic Liquid Catalyst

Alkylation of isobutane with 2-butene was carried out in a 300 cc continuously stirred autoclave. 8 grams of tributyldodecylphosphonium (TBDDP)-Al₂Cl₇ ionic liquid and 80 grams of isobutane were charged into the autoclave in a glovebox to avoid exposure to moisture. The autoclave was then pressured to 500 psig using nitrogen. Stirring was started at 1900 rpm. 8 grams of olefin feed (2-butene feed to which 10% n-pentane tracer was added) was then charged into the autoclave at an olefin space velocity of 0.5 g olefin/g IL/hr until the target i/o molar ratio of 10:1 was reached. Stirring was stopped and the ionic liquid and hydrocarbon phases were allowed to settle for 30 seconds. (Actual separation was almost instantaneous). The hydrocarbon phase was then analyzed by GC. For this example, the autoclave temperature was maintained at 25° C.

TABLE 1
Alkylation with TBDDP-Al₂Cl₇ Ionic Liquid catalyst

| | |
|---|---|
| Olefin Conversion, wt % | 100.0 |
| C₅+ Yield, wt. alkylate/wt olefin | 2.25 |
| C₅+ Alkylate RON-C | 95.7 |
| C₅-C₇ Selectivity, wt % | 15 |
| C₈ Selectivity, wt % | 77 |
| C₉+ Selectivity, wt % | 8 |
| TMP/DMH | 13.7 |

### Examples 3-30

The procedures of Example 2 were repeated with a series of different phosphonium chloroaluminate ionic liquid catalysts at 25° C. (Table 2), 38° C. (Table 3), and 50° C. (Table 4). Four imidazolium or pyridinium ionic liquids were included to show the performance differences between P-based and N-based ionic liquids. The ionic liquids were: A—Tributyldodecyl phosphonium-Al₂Cl₇, B—Tributyldecyl phosphonium-Al₂Cl₇, C—Tributyloctyl phosphonium-Al₂Cl₇, D—Tributylhexyl phosphonium-Al₂Cl₇ E—Tributylpentyl phosphonium-Al₂Cl₇, F—Tributylmethyl phosphonium-Al₂Cl₇, G—Tripropylhexyl phosphonium-Al₂Cl₇, H—Butylmethyl imidazolium-Al₂Cl₇, I—Octylmethyl imidazolium-Al₂Cl₇, J—Butyl pyridinium-Al₂Cl₇, and K—Hexadecyl pyridinium-Al₂Cl₇.

TABLE 2
Experimental Runs at 25° C.

| | Example | | | | | | | | | | |
|---|---|---|---|---|---|---|---|---|---|---|---|
| | 2 | 3 | 4 | 5 | 6 | 7 | 8 | 9 | 10 | 11 | 12 |
| Ionic Liquid | A | B | C | D | E | F | G | H | I | J | K |
| IL Cation | TBDDP | TBDP | TBOP | TBHP | TBPP | TBMP | TPHP | BMIM | OMIM | BPy | HDPy |
| Butene-Conversion, wt % | 100 | 100 | 100 | 100 | 100 | 100 | 100 | 100 | 100 | 100 | 100 |
| Isobutane/Olefin ratio, molar | 10.3 | 9.5 | 10.6 | 10.4 | 11.1 | 10.3 | 9.6 | 9.1 | 11.2 | 11.2 | 10.4 |
| IL/Olefin ratio, wt/wt | 1.07 | 0.98 | 1.10 | 1.07 | 1.15 | 1.09 | 0.99 | 0.94 | 1.16 | 1.18 | 1.07 |
| Temperature, ° C. | 25 | 25 | 25 | 25 | 25 | 25 | 25 | 25 | 25 | 25 | 25 |
| Pressure, psig | 500 | 500 | 500 | 500 | 500 | 500 | 500 | 500 | 500 | 500 | 500 |
| C5+ Alkylate Yield, w/w olefin | 2.25 | 2.08 | 2.13 | 2.13 | 2.20 | 2.00 | 2.18 | 2.01 | 2.08 | 2.10 | 2.17 |
| C5+ Product Selectivity, wt % | | | | | | | | | | | |
| C5-C7 | 15 | 12 | 11 | 10 | 8 | 10 | 14 | 10 | 14 | 10 | 20 |
| C8 | 77 | 80 | 82 | 84 | 87 | 85 | 78 | 83 | 79 | 84 | 69 |
| C9+ | 8 | 8 | 7 | 6 | 5 | 5 | 8 | 7 | 7 | 6 | 11 |
| TMP/DMH | 13.7 | 17.3 | 22.6 | 18.0 | 25.4 | 10.6 | 8.2 | 8.4 | 7.7 | 7.5 | 10.8 |
| C5+ Alkylate RON-C | 95.7 | 96.5 | 97.5 | 97.2 | 98.4 | 96.1 | 94.4 | 94.9 | 94.3 | 94.6 | 93.6 |

TABLE 3
Experimental Runs at 38° C.

| | Example | | | | | | | |
|---|---|---|---|---|---|---|---|---|
| | 13 | 14 | 15 | 16 | 17 | 18 | 19 | 20 |
| Ionic Liquid | A | C | D | E | F | H | J | K |
| IL Cation | TBDDP | TBOP | TBHP | TBPP | TBMP | BMIM | BPy | HDPy |
| Butene-Conversion, wt % | 100 | 100 | 100 | 100 | 100 | 100 | 100 | 100 |
| Isobutane/Olefin ratio, molar | 8.8 | 9.0 | 10.4 | 10.1 | 10.5 | 8.8 | 11.7 | 11.8 |
| IL/Olefin ratio, wt/wt | 0.91 | 0.94 | 1.10 | 0.97 | 1.06 | 0.92 | 1.21 | 1.23 |
| Temperature, ° C. | 38 | 38 | 38 | 38 | 38 | 38 | 38 | 38 |
| Pressure, psig | 500 | 500 | 500 | 500 | 500 | 500 | 500 | 500 |
| C5+ Alkylate Yield, w/w olefin | 2.20 | 2.14 | 2.07 | 2.06 | 2.03 | 2.18 | 2.10 | 2.18 |
| C5+ Product Selectivity, wt % | | | | | | | | |
| C5-C7 | 29 | 16 | 12 | 15 | 16 | 16 | 13 | 24 |
| C8 | 61 | 76 | 81 | 74 | 75 | 76 | 87 | 64 |
| C9+ | 10 | 8 | 7 | 11 | 9 | 8 | 10 | 12 |
| TMP/DMH | 7.6 | 7.4 | 15.3 | 19.4 | 5.5 | 4.9 | 5.4 | 7.2 |
| C5+ Alkylate RON-C | 93.2 | 93.8 | 96.6 | 96.2 | 92.3 | 91.6 | 92.5 | 92.1 |

TABLE 4
Experimental Runs at 50° C.

| | Example | | | | | | | | | |
|---|---|---|---|---|---|---|---|---|---|---|
| | 21 | 22 | 23 | 24 | 25 | 26 | 27 | 28 | 29 | 30 |
| Ionic Liquid | A | C | D | E | F | G | H | I | J | K |
| IL Cation | TBDDP | TBOP | TBHP | TBPP | TBMP | TPHP | BMIM | OMIM | BPy | HDPy |
| Butene-Conversion, wt % | 100 | 100 | 100 | 100 | 100 | 100 | 100 | 100 | 99 | 100 |
| Isobutane/Olefin ratio, molar | 8.6 | 11.5 | 10.5 | 15.0 | 9.6 | 8.8 | 9.4 | 9.5 | 10.8 | 10.0 |
| IL/Olefin ratio, wt/wt | 0.9 | 1.06 | 1.09 | 1.55 | 1.01 | 0.91 | 0.97 | 0.98 | 1.11 | 1.04 |
| Temperature, ° C. | 50 | 50 | 50 | 50 | 50 | 50 | 50 | 50 | 50 | 50 |
| Pressure, psig | 500 | 500 | 500 | 500 | 500 | 500 | 500 | 500 | 500 | 500 |
| C5+ Alkylate Yield, w/w olefin | 2.22 | 2.09 | 2.08 | 2.09 | 2.22 | 2.23 | 2.11 | 2.13 | 2.03 | 2.14 |
| C5+ Product Selectivity, wt % | | | | | | | | | | |
| C5-C7 | 25 | 21 | 16 | 15 | 25 | 28 | 22 | 43 | 18 | 26 |
| C8 | 63 | 69 | 76 | 77 | 65 | 59 | 68 | 43 | 73 | 61 |
| C9+ | 12 | 10 | 8 | 8 | 11 | 13 | 10 | 14 | 9 | 13 |
| TMP/DMH | 5.0 | 4.8 | 8.5 | 7.0 | 3.5 | 3.5 | 3.1 | 1.3 | 3.8 | 4.5 |
| C5+ Alkylate RON-C | 90.8 | 91.2 | 94.4 | 93.7 | 88.7 | 88.2 | 87.8 | 82.4 | 89.4 | 90.1 |

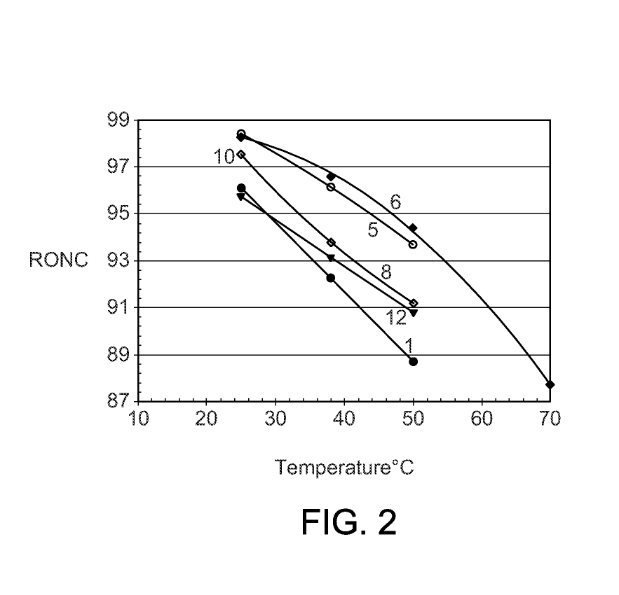

Based on screening this series of phosphonium-based chloroaluminate ionic liquids, we have discovered a good candidate capable of producing high octane alkylate even when run at 50° C. As shown in FIG. 2, being able to design the ionic liquid with an appropriate carbon chain length has an impact on the product quality. FIG. 2 shows the optimized octane as a function of temperature for different chloroaluminate ionic liquids. The figure shows the results for TBMP-1 (tributylmethylphosphonium chloroaluminate), TBPP-5 (tributylpentylphosphonium chloroaluminate), TBHP-6 (tributylhexylphosphonium chloroaluminate), TBOP-8 (tributyloctylphosphonium chloroaluminate), TBDP-10 (tributyldecylphosphonium chloroaluminate), and TBDDP 12 (tributyldodecylphosphonium chloroaluminate). The optimum length of the asymmetric side-chain (R₄ in PR₁R₂R₃R₄—Al₂Cl₇, where R₁=R₂=R₃≠R₄) is in the 5 or 6 carbon number range. Note that if there is not at least one asymmetric side chain, the ionic liquid may crystallize and not remain a liquid in the temperature range of interest. If the asymmetric chain is too long, it may be subject to isomerization and cracking FIG. 3 shows the drop in performance when the size of symmetric side chain (R₁=R₂=R₃) is reduced from C₄ to C₃. FIG. 3 is a plot of the optimized octane as a function of temperature for different chloroaluminate ionic liquids, showing TPHP (tripropylhexylphosphonium chloroaluminate) and TBHP (tributylhexylphosphonium chloroaluminate). Without being bound by theory it appears that the butyl side chains provide for better association and solubility with the isobutane and butene feed components and that this may help to maintain a high local i/o at the active site.

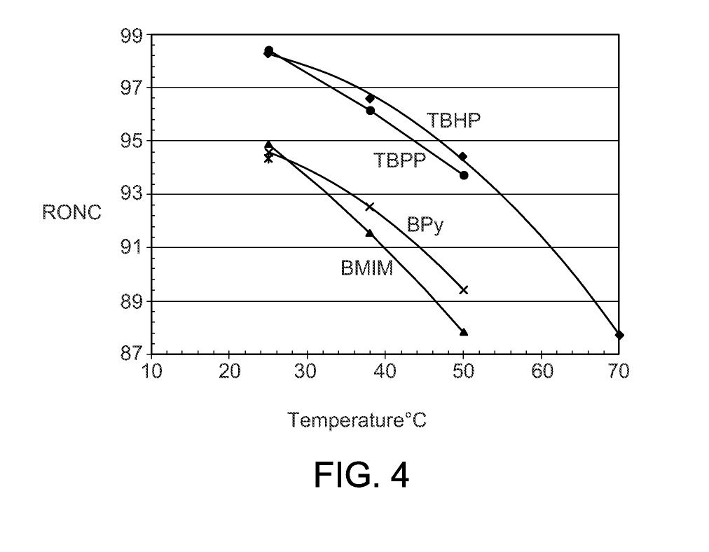

FIGS. 4 and 5 compare the performance of the better phosphonium-chloroaluminate ionic liquids with several nitrogen-based ionic liquids, including 1-butyl-3-methyl imidazolium (BMIM) chloroaluminate and N-butyl pyridinium (BPy) chloroaluminate, which have been widely used and reported in the literature. FIG. 4 shows the optimized octane as a function of temperature for the ionic liquids TBHP (tributylhexylphosphonium chloroaluminate), TBPP (tributylpentylphosphonium chloroaluminate), BPy (butyl pyridinium chloroaluminate), and BMIM (butyl-methyl-imidazolium chloroaluminate). FIG. 5 shows the difference in product selectivities for P-based versus N-based chloroaluminate ionic liquids. The phosphonium-based ionic liquids gave consistently better TMP to DMH ratios and better Research Octane numbers than the nitrogen-based ionic liquids. Whereas the alkylate RONC dropped off below 90 for the nitrogen-based ionic liquids as the temperature was increased to 50° C., the phosphonium ionic liquids were still able to provide a Research Octane Number of ˜95. This provides an economic advantage when designing the alkylation unit in that expensive refrigeration equipment is not needed, and/or the unit can be operated at lower i/o ratio for a given product quality.

While the invention has been described with what are presently considered the preferred embodiments, it is to be understood that the invention is not limited to the disclosed embodiments, but it is intended to cover various modifications and equivalent arrangements included within the scope of the appended claims, and that the invention also contemplates multiply dependent embodiments of the appended claims where appropriate.

What is claimed is:

1. A quaternary phosphonium haloaluminate compound according to Formula (I): 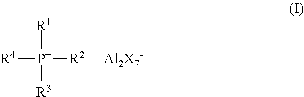
wherein
R¹-R³ are the same or different and each is chosen from a C₁-C₈ hydrocarbyl;
R⁴ is different than R¹-R³ and is chosen from a C₁-C₁₅ hydrocarbyl; and
X is a halogen.

2. A compound according to Formula (I) of claim 1, wherein R¹-R³ are the same.

3. A compound according to Formula (I) of claim 2, wherein R⁴ comprises at least one more carbon atom than each of R¹-R³.

4. A compound according to Formula (I) of claim 1, wherein R⁴ is a C₄-C₁₂ hydrocarbyl.

5. A compound according to Formula (I) of claim 2, wherein each of R¹-R³ is a C₃-C₆ alkyl.

6. A compound according to Formula (I) of claim 5, wherein each of R¹-R³ is butyl.

7. A compound according to Formula (I) of claim 1, wherein R⁴ is a C₅-C₈ alkyl.

8. A compound according to Formula (I) of claim 7, wherein R⁴ is pentyl or hexyl.

9. A compound according to Formula (I) of claim 1, wherein the quaternary phosphonium haloaluminate is selected from the group consisting of tripropylhexylphosphonium-Al₂X₇; tributylmethylphosphonium-Al₂X₇; tributylpentylphosphonium-Al₂X₇; tributylhexylphosphonium-Al₂X₇; tributylheptylphosphonium-Al₂X₇; tributyloctylphosphonium-Al₂X₇; tributylnonylphosphonium-Al₂X₇; tributyldecylphosphonium-Al₂X₇; tributylundecylphosphonium-Al₂X₇; tributyldodecylphosphonium-Al₂X₇; and tributyltetradecylphosphonium-Al₂X₇.

10. A compound according to Formula (I) of claim 9, wherein the quaternary phosphonium haloaluminate is tributylpentylphosphonium-Al₂X₇.

11. A compound according to Formula (I) of claim 9, wherein the quaternary phosphonium haloaluminate is tributylhexylphosphonium-Al₂X₇.

12. A compound according to Formula (I) of claim 11, wherein the quaternary phosphonium haloaluminate is tri-n-butyl-hexylphosphonium-Al₂X₇.

13. A compound according to Formula (I) of claim 9, wherein the quaternary phosphonium haloaluminate is tributylheptylphosphonium-Al₂X₇.

14. A compound according to Formula (I) of claim 9, wherein the quaternary phosphonium haloaluminate is tributyloctylphosphonium-Al₂X₇.

15. A compound according to Formula (I) of claim 9, wherein the quaternary phosphonium haloaluminate is tributyldodecylphosphonium-Al₂X₇.

16. A compound according to Formula (I) of claim 1, wherein X is selected from the group consisting of F, Cl, Br, and I.

17. A compound according to Formula (I) of claim 16, wherein X is Cl.

18. An ionic liquid composition comprising one or more quaternary phosphonium haloaluminate compounds as defined in claim 1.

19. An ionic liquid composition according to claim 18, wherein the one or more quaternary phosphonium haloaluminate is selected from the group consisting of tripropylhexylphosphonium-Al₂X₇; tributylmethylphosphonium-Al₂X₇; tributylpentylphosphonium-Al₂X₇; tributylhexylphosphonium-Al₂X₇; tributylheptylphosphonium-Al₂X₇; tributyloctylphosphonium-Al₂X₇; tributylnonylphosphonium-Al₂X₇; tributyldecylphosphonium-Al₂X₇; tributylundecylphosphonium-Al₂X₇; tributyldodecylphosphonium-Al₂X₇; and tributyltetradecylphosphonium-Al₂X₇.

20. An ionic liquid catalyst for reacting olefins and isoparaffins to generate an alkylate, said catalyst comprising a quaternary phosphonium haloaluminate compound as defined in claim 1.

21. An ionic liquid catalyst according to claim 20, wherein the catalyst has an initial kinematic viscosity of at least 50 cSt at a temperature of 20° C.

22. An ionic liquid catalyst according to claim 20, wherein the catalyst has an initial kinematic viscosity of at least 20 cSt at a temperature of 50° C.

23. An ionic liquid catalyst according to claim 20, wherein the boiling point at atmospheric pressure of HR4 of the phosphonium haloaluminate compound is at least 30° C. greater than the boiling point at atmospheric pressure of HR1.

24. An ionic liquid catalyst according to claim 20 further comprising a co-catalyst, wherein said ionic liquid catalyst is coupled with the co-catalyst.

25. An ionic liquid catalyst according to claim 24, wherein the co-catalyst is a Brønsted acid selected from the group consisting of HCl, HBr, HI, and mixtures thereof.

26. An ionic liquid catalyst according to claim 25, wherein said Brønsted acid co-catalyst is HCl.
